(19) United States
(12) Patent Application Publication
(10) Pub. No.: US 2005/0105858 A1
(43) Pub. Date: May 19, 2005

(54) Sleeve assembly having means of fixing optical fibers without using adhesive

(76) Inventor: Chen-Hung Hung, Chia-Yi Hsien (TW)

Correspondence Address: Bruce H. Troxell, 5205 Leesburg Pike, Suite 1404, Falls Church, VA, 22041, US

(21) Appl. No.: 10/705,986

(22) Filed: Nov. 13, 2003

(51) Int. Cl. G02B 6/36

(52) U.S. Cl. 385/81

(57) ABSTRACT

A sleeve assembly of fiber optical connector is disclosed. The sleeve assembly comprises a sleeve comprising a hollow head including a top hole and a cavity in communication with the top hole, and a tube member having one end secured to the head; and a hollow base for receiving the other end of the tube member. Heating the head will expand the top hole for enabling an insertion of strands of optical fiber through the top hole with a bundle of optical fibers received in the cavity, the tube member, and the base; and cooling the head will contract the top hole to fasten the strands of optical fiber, and using a tool to compress the base will decrease its diameter for fastening the bundle of optical fibers. The invention can increase the transmission distance and improve the transmission quality.

### BACKGROUND OF THE INVENTION

1. Field of the Invention

The present invention relates to sleeve assemblies and more particularly to an improved sleeve assembly having means of fixing one or more strands of optical fiber without using adhesive.

2. Description of Related Art

Fiber optics as means of transmitting light and images has been widely employed due to its features of small diameter, wide bandwidth, low transmission loss, etc. A fiber optical communication system comprises a trunk including a plurality of branches each extended to an end user. Conventionally, a plurality of fiber optical connectors, interconnected the branch and the end user, are provided for increasing the transmission distance.

A conventional sleeve assembly 1 of the fiber optical connector is shown in FIG. 1. The sleeve assembly 1 is coupled to a bundle of optical fibers 2 including one or more strands of optical fiber 7 (one strand of optical fiber as shown). The sleeve assembly 1 comprises an elongated sleeve 3 and an elongated base 4 coupled to one end of the sleeve 3. A channel 5 is longitudinally formed along the axis of the sleeve 3 for receiving the strand of optical fiber 7. The channel 5 is in communication with a longitudinal tunnel 6 of the base 4. The strand of optical fiber 7 is surrounded by a layer of insulating medium 8. Also, the layer of insulating medium 8 is surrounded by a buffer layer 9 which is, in turn, received in the tunnel 6. End portions of the layer of insulating medium 8 and the buffer layer 9 are ripped to expose a small length of the strand of optical fiber 7. Further, adhesive 10 is coated on the strand of optical fiber 7 and the buffer layer 9 so as to fix within the sleeve assembly 1 after the adhesive 10 has been cured.

But this is unsatisfactory for the purpose for which the invention is concerned for the following reasons: Bubbles may form in the adhesive 10. Also, bubbles may move slightly due to expansion or contraction caused by temperature change. Such can adversely affect the transmission quality. Moreover, it is seen from the above that the forming of adhesive 10 comprises the steps of coating adhesive, heating, cooling for curing, removing adhesive from the end portions of the layer of insulating medium 8 and the buffer layer 9, and polishing. This is a tedious process. Hence, a need for improvement exists.

### SUMMARY OF THE INVENTION

It is an object of the present invention to provide a sleeve assembly of a fiber optical connector, the sleeve assembly being connectable to a bundle of optical fibers without using adhesive. The sleeve assembly comprises one or more strands of optical fiber having an exposed end portion, a layer of insulating medium for surrounding the strands of optical fiber, and a buffer layer for surrounding the layer of insulating medium. The sleeve assembly comprises a sleeve comprising a hollow head including a top hole having a diameter slightly smaller than that of the strands of optical fiber, and a cavity in communication with the top hole, the cavity being adapted to receive the bundle of optical fibers, and a tube member including an axial channel, the tube member being formed to fasten the head at on end thereof by heating and cooling; and a hollow, cylindrical base comprising a recess at one end for snugly receiving the other end of the tube member, and an axial tunnel in communication with the recess and the channel, the tunnel being adapted to receive the bundle of optical fibers, whereby heating the head will expand the top hole for enabling an insertion of the strands of optical fiber through the top hole with the bundle of optical fibers received in the cavity, the channel, and the tunnel; and cooling the head will contract the top hole to fasten the strands of optical fiber, and using a tool to compress the base will decrease its diameter for fastening the bundle of optical fibers. By utilizing the present invention, it is possible of increasing the transmission distance and greatly improving the transmission quality.

In one aspect of the present invention the head further comprises a conic portion and a hollow, cylindrical bottom extension with the cavity received therein, and the tube member further comprises an end well for receiving the extension.

In another aspect of the present invention the tube member further comprises an end extension adapted to receive in the cavity.

In still another aspect of the present invention the tube member further comprises an end well for receiving the head.

The above and other objects, features and advantages of the present invention will become apparent from the following detailed description taken with the accompanying drawings.

### BRIEF DESCRIPTION OF THE DRAWINGS

FIG. 1 is a cross-sectional view of a conventional sleeve assembly of the fiber optical connector;

FIG. 2A is a perspective view of a first preferred embodiment of sleeve assembly of the fiber optical connector according to the invention;

FIG. 2B is a cross-sectional view of the FIG. 2A sleeve assembly;

FIG. 3 is a cross-sectional view of the FIG. 2B head;

FIG. 4 is a cross-sectional view of the FIG. 2B tube member;

FIG. 5 is a cross-sectional view of the FIG. 2B base;

FIG. 6 is a cross-sectional view showing the FIG. 2B sleeve assembly coupled to the bundle of optical fibers;

FIG. 7A is a perspective view of a second preferred embodiment of sleeve assembly of the fiber optical connector according to the invention;

FIG. 7B is a cross-sectional view of the FIG. 7A sleeve assembly;

FIG. 8 is a cross-sectional view of the FIG. 7B head;

FIG. 9 is a cross-sectional view of the FIG. 7B tube member;

FIG. 10 is a cross-sectional view showing the FIG. 7B sleeve assembly coupled to the bundle of optical fibers;

FIG. 11A is a perspective view of a third preferred embodiment of sleeve assembly of the fiber optical connector according to the invention;

FIG. 11B is a cross-sectional view of the FIG. 11A sleeve assembly;

FIG. 12 is a cross-sectional view of the FIG. 11B head;

FIG. 13 is a cross-sectional view of the FIG. 11B tube member; and

FIG. 14 is a cross-sectional view showing the FIG. 11B sleeve assembly coupled to the bundle of optical fibers.

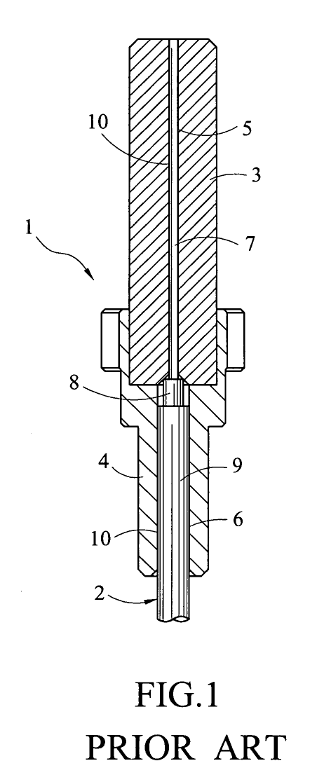

### DETAILED DESCRIPTION OF THE PREFERRED EMBODIMENTS

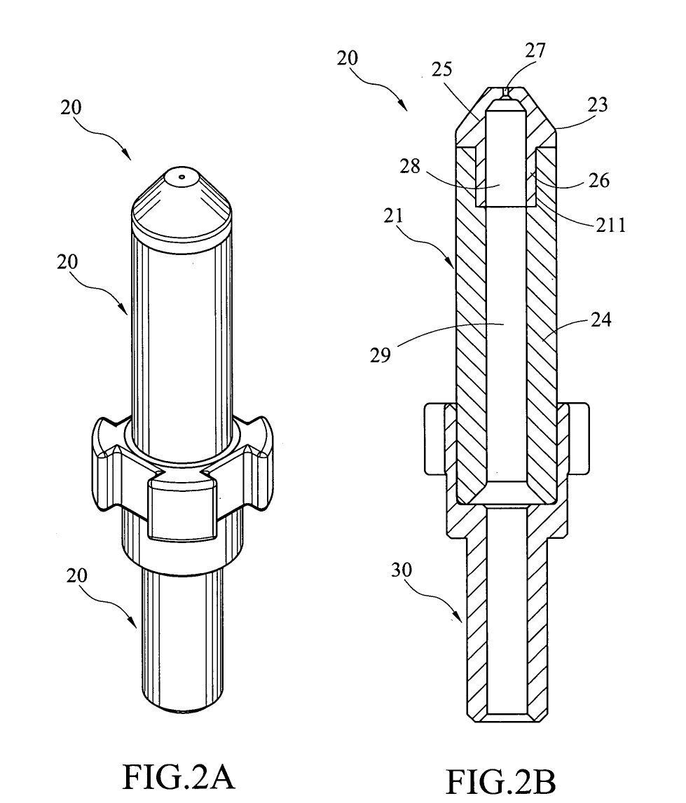

Referring to FIGS. 2A to 6, there is shown an elongated sleeve assembly 20 of a fiber optical connector constructed in accordance with a first preferred embodiment of the invention. The sleeve assembly 20 is coupled to a bundle of optical fibers 40. The bundle of optical fibers 40 comprises one or more strands of optical fiber 41 (one strand of optical fiber as shown) a layer of insulating medium 42 for surrounding the strand of optical fiber 41, and a buffer layer 43 for surrounding the layer of insulating medium 42. End portions of the layer of insulating medium 42 and the buffer layer 43 are ripped to expose a small length of the strand of optical fiber 41. The sleeve assembly 20 comprises a sleeve 21 including a head 23 and a tube member 24, and a base 30.

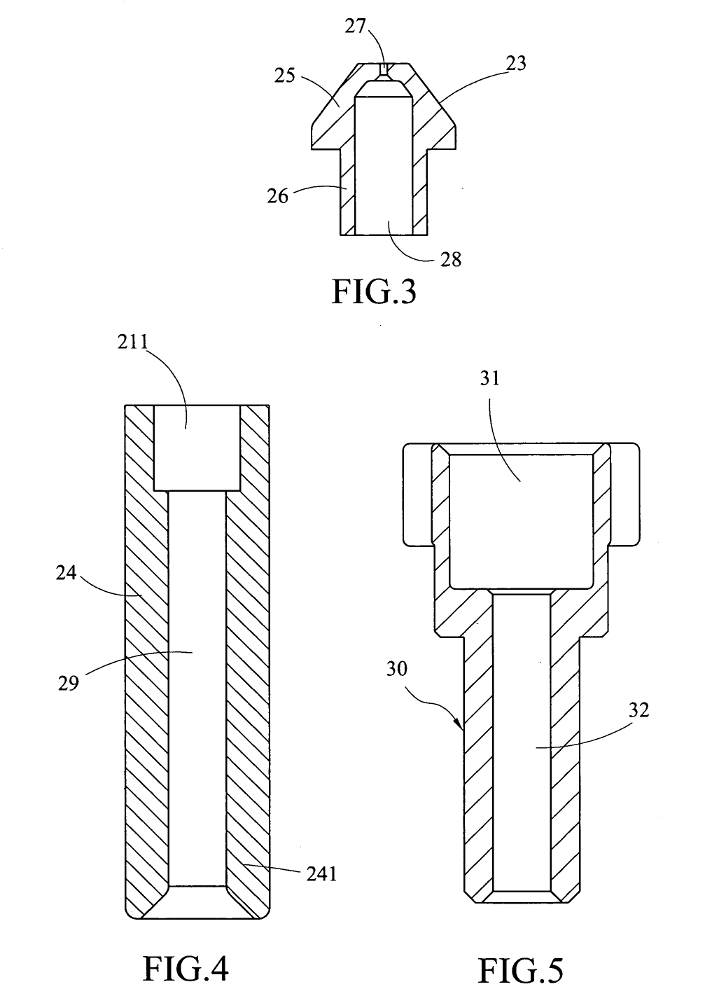

Referring to FIG. 3 specifically, the head 23 comprises a conic portion 25, a top hole 27 on the conic portion 25, the top hole 27 having a diameter slightly smaller than that of the strand of optical fiber 41, a hollow, cylindrical bottom extension 26, and a bore 28 in communication with the top hole 27, the bore 28 being adapted to receive the bundle of optical fibers 40.

Referring to FIG. 4 specifically, the tube member 24 comprises a cavity 211 at one end, the cavity 211 having a diameter smaller than that of the extension 26, and an axial channel 29 for receiving the bundle of optical fibers 40. For fastening the tube member 24 and the head 23 together, heat the tube member 24 to cause the cavity 211 to expand slightly so as to fit the extension 26. Next, cool it to cause the tube member 24 to contract to fasten the extension 26 in the cavity 211 (i.e., the tube member 24 and the head 23 are fastened together as shown in FIG. 2B).

Referring to FIG. 5 specifically, the base 30 is made of metal material. The hollow, cylindrical base 30 comprises a recess 31 at one end for snugly receiving the other end of the tube member 24, and an axial tunnel 32 in communication with the recess 31 and the channel 29 (see FIG. 2B). The tunnel 32 has a diameter sufficient to receive the bundle of optical fibers 40.

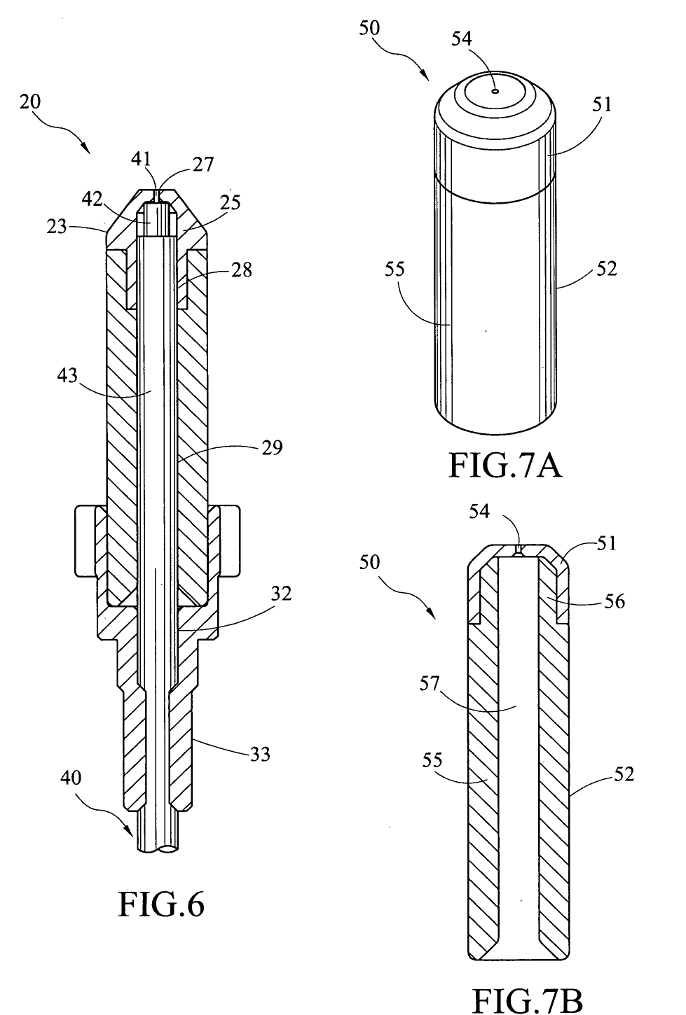

For coupling the sleeve assembly 20 and the bundle of optical fibers 40 together, heat the head 23 to expand the top hole 27 prior to inserting the strand of optical fiber 41 through the top hole 27 with both the buffer layer 42 and the layer of insulating medium 43 received in the communicated bore 28, the channel 29, and the tunnel 32. Next, cool the head 23 to cause the top hole 27 to contract to fasten the strand of optical fiber 41 therein (see FIG. 6). Finally, use a tool to compress the base 30 so as to decrease its diameter. As an end, the bundle of optical fibers 40 is fastened in the reduced diameter portion 33 of the base 30.

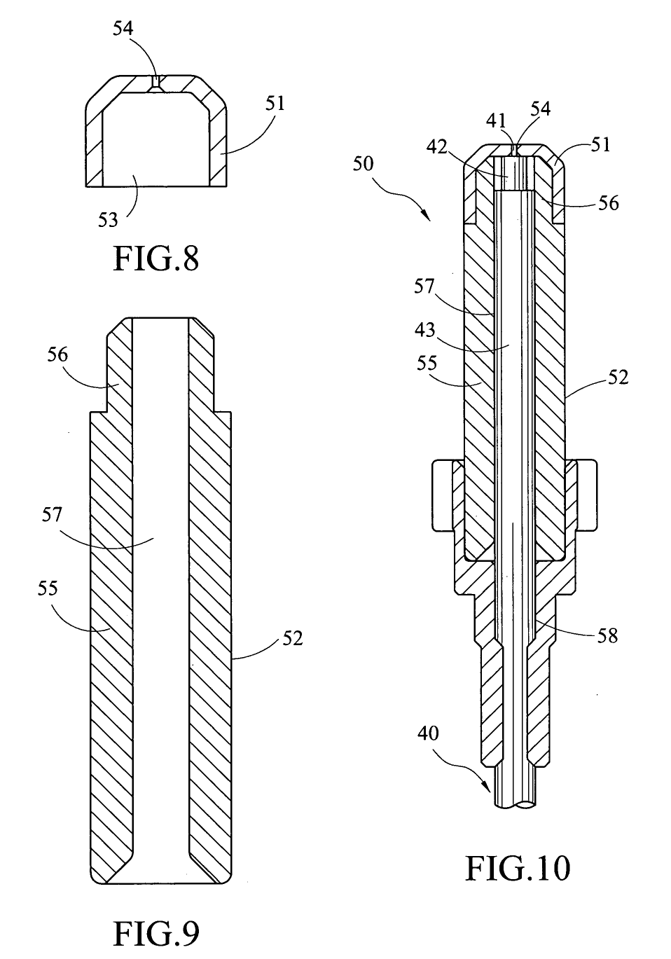

Referring to FIGS. 7A to 10, there is shown an elongated sleeve assembly 50 of the fiber optical connector constructed in accordance with a second preferred embodiment of the invention. The sleeve assembly 50 comprises a head 51 and a tube member 52. Referring to FIG. 8 specifically, the hollow head 51 comprises a top hole 54 having a diameter slightly smaller than that of the strand of optical fiber 41, and a cylindrical cavity 53. Referring to FIG. 9 specifically, the tube member 52 comprises a hollow, cylinder 55 having an axial channel 57 for snugly receiving the bundle of optical fibers 40, and a top extension 56 having a diameter slightly larger than that of the cavity 53.

For coupling the head 51 and the tube member 52 together, heat the head 51 to expand the cavity 53 prior to inserting the extension 56 into the cavity 53. Next, cool the head 51 to cause the cavity 53 to contract to fasten the extension 56 therein (i.e., the head 51 and the tube member 52 are fastened together as shown in FIG. 7B).

Referring to FIG. 10 specifically, for coupling the sleeve assembly 50 and the bundle of optical fibers 40 together, heat the head 51 to expand the top hole 54 prior to inserting the strand of optical fiber 41 through the top hole 54 with both the buffer layer 42 and the layer of insulating medium 43 received in the communicated channel 57 and the tunnel 58. Next, cool the head 51 to cause the top hole 54 to contract to fasten the strand of optical fiber 41 therein.

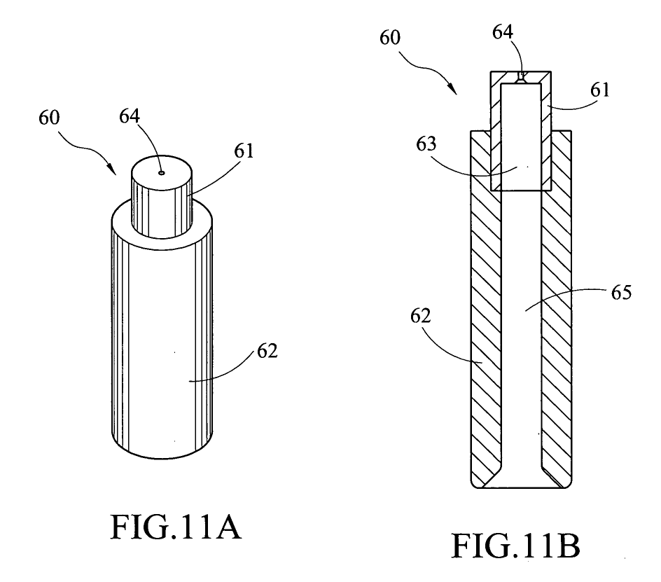

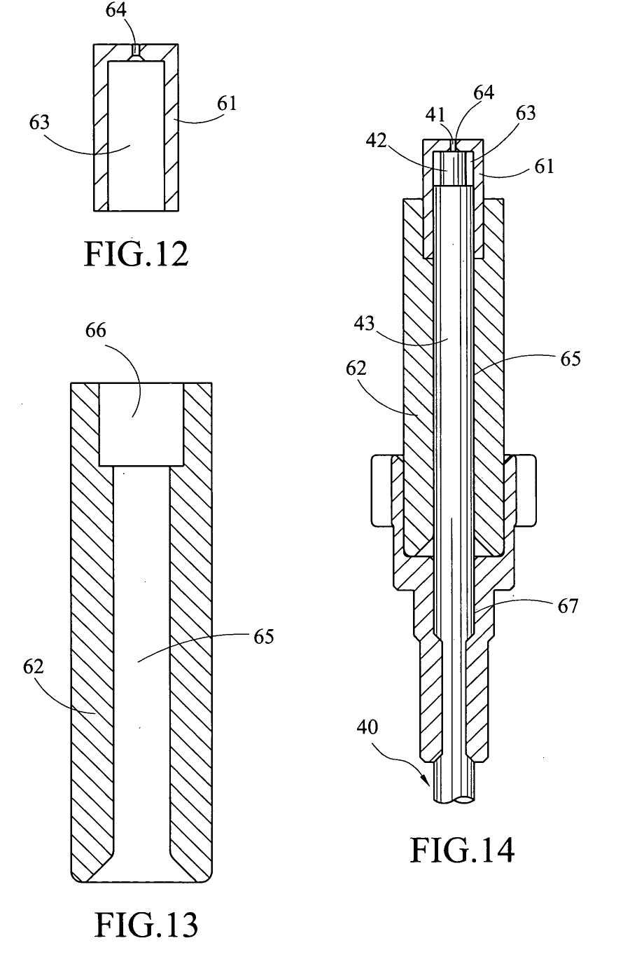

Referring to FIGS. 11A to 14, there is shown an elongated sleeve assembly 60 of the fiber optical connector constructed in accordance with a third preferred embodiment of the invention. The sleeve assembly 60 comprises a head 61 and a tube member 62. Referring to FIG. 12 specifically, the hollow, cylindrical head 61 comprises a top hole 64 having a diameter slightly smaller than that of the strand of optical fiber 41, and a cylindrical cavity 63. Referring to FIG. 13 specifically, the tube member 62 comprises an axial channel 65 for snugly receiving the bundle of optical fibers 40, and a top cavity 66 having a diameter slightly smaller than that of the head 61.

For coupling the head 61 and the tube member 62 together, heat the tube member 62 to expand the cavity 66 prior to inserting a portion of the head 61 into the cavity 66. Next, cool the tube member 62 to cause the cavity 66 to contract to fasten the head 61 therein (i.e., the head 61 and the tube member 62 are fastened together as shown in FIG. 11B).

Referring to FIG. 14 specifically, for coupling the sleeve assembly 60 and the bundle of optical fibers 40 together, heat the head 61 to expand the top hole 64 prior to inserting the strand of optical fiber 41 through the top hole 64 with both the buffer layer 42 and the layer of insulating medium 43 received in the communicated channel 65 and the tunnel 67. Next, cool the head 61 to cause the top hole 64 to contract to fasten the strand of optical fiber 41 therein.

Note that the formed fiber optical connector is readily adapted to mount on a fiber optical relay. Most importantly, the invention can increase the transmission distance and greatly improve the transmission quality.

While the invention herein disclosed has been described by means of specific embodiments, numerous modifications and variations could be made thereto by those skilled in the art without departing from the scope and spirit of the invention set forth in the claims.

1. A sleeve assembly of a fiber optical connector, the sleeve assembly being connectable to a bundle of optical fibers including one or more strands of optical fiber having an exposed end portion, a layer of insulating medium for surrounding the strands of optical fiber, and a buffer layer for surrounding the layer of insulating medium, the sleeve assembly comprising:
a sleeve comprising a hollow head including a top hole having a diameter slightly smaller than that of the strands of optical fiber, and a cavity in communication with the top hole, the cavity being adapted to receive the bundle of optical fibers, and a tube member including an axial channel, the tube member being formed to fasten the head at on end thereof by heating and cooling; and
a hollow, cylindrical base comprising a recess at one end for snugly receiving the other end of the tube member, and an axial tunnel in communication with the recess and the channel, the tunnel being adapted to receive the bundle of optical fibers,
whereby heating the head will expand the top hole for enabling an insertion of the strands of optical fiber through the top hole with the bundle of optical fibers received in the cavity, the channel, and the tunnel; and cooling the head will contract the top hole to fasten the strands of optical fiber, and using a tool to compress the base will decrease its diameter for fastening the bundle of optical fibers.

2. The sleeve assembly of claim 1, wherein the head further comprises a conic portion and a hollow, cylindrical bottom extension with the cavity received therein, and the tube member further comprises an end well for receiving the extension.

3. The sleeve assembly of claim 1, wherein the tube member further comprises an end extension adapted to receive in the cavity.

4. The sleeve assembly of claim 1, wherein the tube member further comprises an end well for receiving the head.
